(19) United States
(12) Patent Application Publication
(10) Pub. No.: US 2007/0290031 A1
(43) Pub. Date: Dec. 20, 2007

(54) System and method for implementing scanable coupons in document processing devices

(75) Inventor: Harpreet Singh, Orange, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/452,737

(22) Filed: Jun. 14, 2006

(51) Int. Cl. G06F 17/00

(52) U.S. Cl. 235/375

(57) ABSTRACT

A system and method for scanning coupons for document processing devices is provided. Visible scanning indicia on a coupon, such as a barcode, includes encoded data representing a pre-selected value associated with the use of a document processing device. The indicia is retrieved by the document processing device, whereupon a value associated with the coupon is determined. A user then initiates a document processing request, following the receipt of which the document processing device calculates any costs associated with performing the request. The calculated costs are then compared to the value of the coupon to determine whether the selected document processing operation is capable of being performed. When enough value is associated with the coupon, the operation is performed and a backend server maintaining the value is updated.

### BACKGROUND OF THE INVENTION

The subject application is directed to a system and method for implementing scanable coupons in document processing devices. In particular, this subject application is directed to a system and method for enabling users of document processing devices or services, particularly those devices located in retail locations, to scan a coupon via a document processing device and then be able to use the device in accordance with the coupon data.

In the current business environment, business travelers need access to document processing services and devices in order to efficiently conduct business. Such users often require that electronic documents be generated, transmitted, or other services be performed while in a remote location. Such users will typically request such services from a retail location, such as hotel business center, an airline service lounge, or a document processing service retail location. In order to access such services, the user will typically pay for the services ahead of time. The retail location will then issue a credit or coupon for the amount paid which the user will then use to access the services accordingly. Typically, the user would have to enter the credit or coupon information into the multifunctional peripheral device or other document processing device in order to access the desired document processing services. This requires that the multifunctional peripheral device include a keyboard or other suitable user interface in order for the user to enter the required coupon data, which adds to the expense and maintenance of such device. In addition, the user may not enter the coupon data correctly, and will be required to reenter the information until it is correct in order to access the device, thereby frustrating the user. As such, there is a need for a system and method for automatically entering coupon data into a multifunctional peripheral device to allow the user to access the services in accordance with the coupon data.

The subject application overcomes the above-noted problems and provides a system and method for implementing scanable coupons for document processing devices.

### SUMMARY OF THE INVENTION

In accordance with the subject application, there is provided a system and method for implementing scanable coupons for a document processing device.

Further, in accordance with the subject application, there is provided a system and method for enabling users of document processing devices or services, particularly those devices located in retail locations, to scan a coupon via a document processing device and then be able to use the device in accordance with the coupon data.

Still further, in accordance with the subject application, there is provided a system for implementing scanable coupons for document processing devices. The system includes scanning means adapted for scanning a visible indicia on an associated tangible document, wherein the visible indicia includes encoded data representative of a pre-selected value associated with use of a document processing device. The system also includes means adapted for generating coupon data in accordance with a scan of visible indicia of a tangible document completed by the scanning means. The system further includes means adapted for receiving a document processing request for the document processing device, means adapted for calculating a charge value associated with a received document processing request, and enabling means adapted for selectively enabling operation of the document processing device in accordance with a calculated charge value and generated coupon data.

Still further, in accordance with the subject application, there is provided a method for implementing scanable coupons in document processing devices. The method includes scanning a visible indicia on an associated tangible document, wherein the visible indicia includes encoded data representative of a pre-selected value associated with use of a document processing device. The method then generates coupon data in accordance with a scan of visible indicia of a tangible document completed by the scanning means. The method also includes the steps of receiving a document processing request for the document processing device and calculating a charge value associated with a received document processing request. The method then selectively enables operation of the document processing device in accordance with a calculated charge value and generated coupon data.

Preferably, in the system and method of the subject application, the enabling operation of the document processing device enables operation of the document processing device to perform a document processing operation specified by the coupon data. Also, preferably, the scanning of the visible indicia includes commencing a scanning of the visible indicia upon receipt of a coupon input signal from an associated user.

In one embodiment, the system and method of the subject application, further include the ability to communicate coupon data via a network to an associated server, generate, at the associated server, credit data corresponding to the coupon data, and communicate credit data from the associated server to the document processing device wherein the enabling means includes means adapted for enabling operation of the document processing device in accordance with the credit data.

In another embodiment, the system and method also include the ability to calculate relative values of the credit data and the charge value and prompt a user for payment data upon a determination by the comparison means that the charge value exceeds the credit data. The system and method further include the ability to receive payment data corresponding to a difference between the charge value and the credit data; and selectively enable operation of the document processing device upon receipt of payment data.

In yet another embodiment, the visible indicia further includes unique identification data corresponding thereto. In this embodiment, the system and method include the ability to generate data representative of at least one of invalidation or value limitation corresponding to the unique identification data upon enabling operation of the document processing device.

Still other advantages, aspects and features of the subject application will become readily apparent to those skilled in the art from the following description wherein there is shown and described a preferred embodiment of this subject application, simply by way of illustration of one of the best modes best suited for to carry out the subject application. As it will be realized, the subject application is capable of other different embodiments and its several details are capable of modifications in various obvious aspects all without departing from the scope of the subject application. Accordingly, the drawing and descriptions will be regarded as illustrative in nature and not as restrictive.

### BRIEF DESCRIPTION OF THE DRAWINGS

The subject application is described with reference to certain figures, including:

FIG. 1 which is an overall system diagram of the system for implementing scanable coupons in document processing devices according to the subject application;

FIG. 2 is a block diagram illustrating controller hardware for use in the system for implementing scanable coupons in document processing devices according to the subject application;

FIG. 3 is a functional block diagram illustrating a controller for use in the system for implementing scanable coupons in document processing devices according to the subject application;

FIG. 4 is a flowchart illustrating the method for generating scanable coupons for document processing devices according to the subject application; and

FIG. 5 is a flowchart illustrating the method for implementing scanable coupons for document processing devices according to the subject application.

### DETAILED DESCRIPTION OF THE PREFERRED EMBODIMENT

The subject application is directed to a system and method for implementing scanable coupons for a document processing device. In particular, the subject application is directed to a system and method for enabling users of document processing devices or services, including those devices located in retail locations, to scan a coupon via a document processing device and then be able to use the device in accordance with the coupon data.

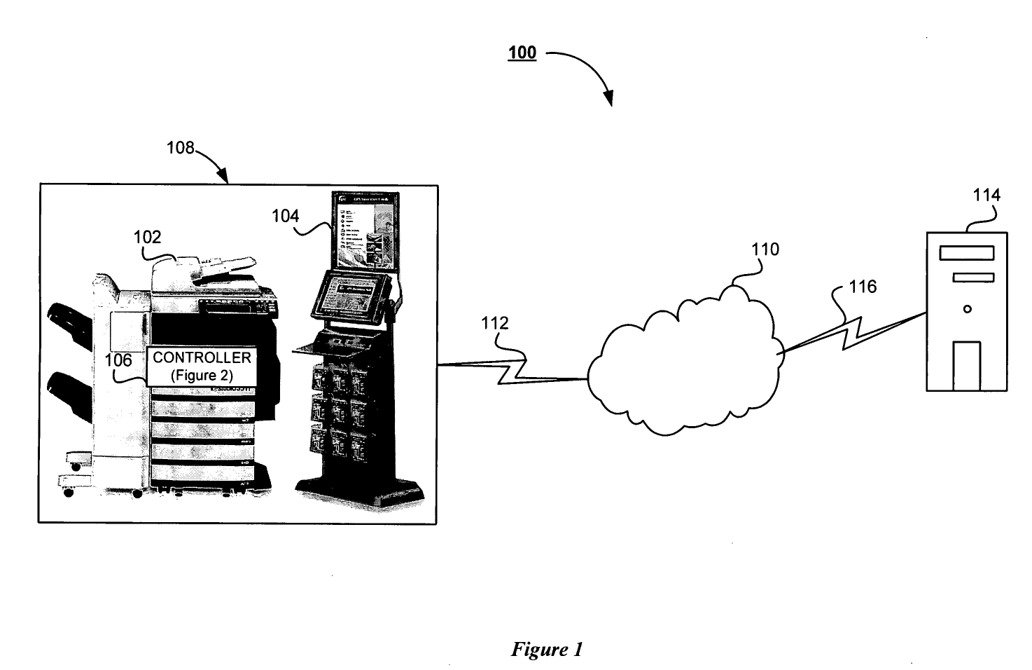

Turning now to FIG. 1, there is shown a diagram illustrating the system 100 in accordance with the subject application. As shown in FIG. 1, a mobile user is provided access to document processing services via a document processing device 102, depicted in FIG. 1 as a multifunctional peripheral device. Preferably, the document processing device 102 is communicatively coupled to an associated controller/user-interface, referenced hereinafter as the user-interface 104. The skilled artisan will appreciate that the combined document processing device 102 and user-interface 104 advantageously form a retail location, kiosk, non-office business center, airport lounge, or the like. In accordance with one aspect of the subject application, the document processing device 102 and the user-interface 104 are located in close proximity forming a document processing services kiosk 108, to which one or more mobile users are able to access a variety of document processing services.

It will be appreciated by those skilled in the art the document processing device 102 is suitably adapted to provide a variety of document processing services, such as, for example and without limitation, electronic mail, scanning, copying, facsimile, document management, printing, and the like. Suitable commercially available document rendering devices include, but are not limited to, the Toshiba e-Studio Series Controller. In one embodiment, the document rendering device 102 is suitably equipped to receive a plurality of portable storage media, including without limitation, Firewire drive, USB drive, SD, MMC, XD, Compact Flash, Memory Stick, and the like. In the preferred embodiment of the subject application, the user-interface 104 is suitably equipped to display a series of interactive graphical screens, whereupon an associated user inputs instructions, selects operations, and the like. It will be appreciated by those skilled in the art that the user-interface 104 is suitably adapted to include, for example and without limitation, an alpha-numeric keypad, mouse, LCD screen, touch-screen interface, or any suitable combination thereof.

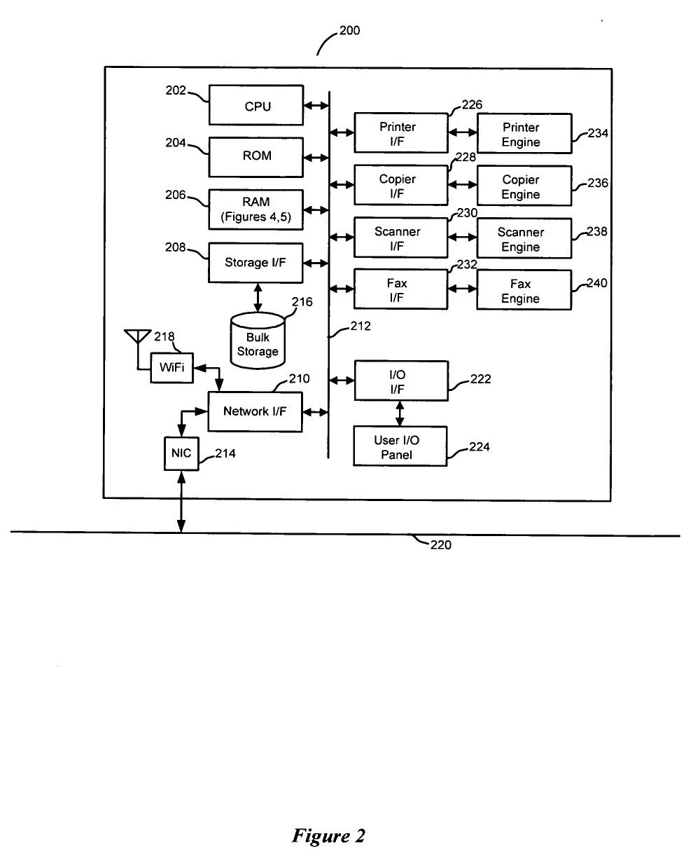

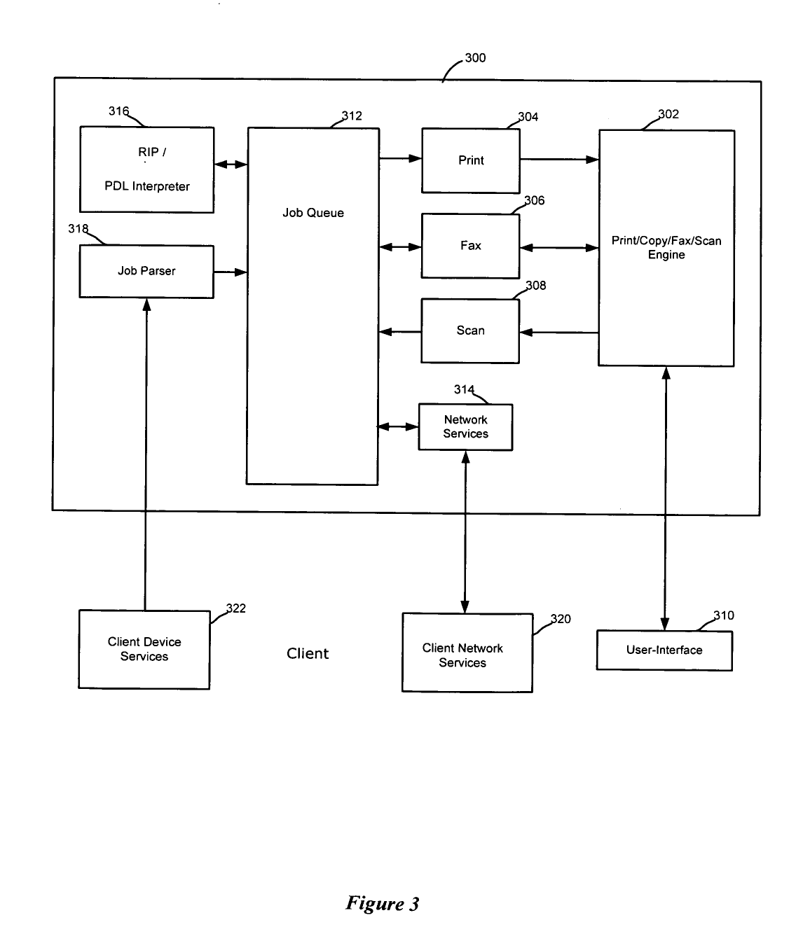

In accordance with the subject application, the first document processing device 102 further incorporates a controller 106, suitably adapted to facilitate the operations of the first document processing device 102, as will be understood by those skilled in the art. Preferably, the controller 106 is embodied as hardware, software, or any suitable combination thereof, configured to control the operations of the associated document processing device 102, control the display of images via the user-interface 104, analyze received coupon data, facilitate communications with external devices, and the like. While the controller 106 is depicted in FIG. 1 as being an integrated component of the document processing device 102, the skilled artisan will appreciate that the controller 106 is suitably capable of being implemented as an external device, communicatively coupled to the document processing device 102. The functioning of the controller 106 will better be understood in conjunction with the block diagrams illustrated in FIGS. 2 and 3, explained in greater detail below.

The skilled artisan will further appreciate, when contemplating FIG. 1, that the kiosk 108 is capable of being a stand-alone structure, situated in, for example and without limitation, a library, airport lounge, hotel business center, or a component of multiple document processing devices and user-interfaces suitably comprising a retail establishment. The kiosk is in data communication with a distributed computing environment, illustrated in FIG. 1 as a computer network 110. As will be understood by those skilled in the art, the computer network 110 is any distributed computing environment known in the art enabling the exchange of data between two or more electronic devices. A suitable computer network includes, but is not limited to, the public switched telephone network, a local area network, a wide area network, the Internet, a personal area network, or the like. Communication between the computer network 110 and the document processing services kiosk 108 is advantageously accomplished via a communications link 112. The communications link 112 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art.

As illustrated in FIG. 1, the system 100 further includes a backend server 114, suitably adapted to provide document management, processing, storage, transmission, account management, and security services to a document services system. It will be understood by those skilled in the art that the document services system is representative of at least one server 114 and one or more kiosks 108, or document processing devices 102, whereupon fee-based document processing operations are carried out. In particular, the skilled artisan will understand that the document services system is administrated by the server 114, which provides and maintains user accounts, coupon generation and management, document storage, electronic mail and messaging, and other similar services. The server 114 is communicatively coupled to the computer network 110 via a suitable communications link 116. As will be understood by those skilled in the art, a suitable communications link 116 employed in accordance with the subject application includes, WiMax, 802.11a, 802.11b, 802.11g, 802.11(x), Bluetooth, the public switched telephone network, a proprietary communications network, infrared, optical, or any other suitable wired or wireless data transmission communications known in the art. It will be appreciated by the skilled artisan that the use of a single kiosks 108 and server 114 are for example purposes only, and the subject application is not limited to a system with these two components. In accordance with the preferred embodiment of the subject application, the server 114 is suitably located remotely from the one or more kiosks of the document services system, advantageously communicating via a wide area network, such as the Internet, proprietary data network, or the like.

In accordance with the subject application, a user purchases access to the document processing services provided by the kiosk 108 prior to using the document processing device 102. Accordingly, the document processing service provider, retail establishment, or kiosk owner, issues a credit, assigned to a user account, or a coupon corresponding to the amount pre-paid by the user. It will be appreciated by those skilled in the art that the amount pre-paid is capable of designating a cash value, a number of selected document processing operations, a number of electronic document transmissions, and the like. It will further be appreciated by those skilled in the art that the user is capable of obtaining such coupons via the kiosk 108, directly from the retail establishment, the document services provider, or the like.

Turning now to FIG. 2, illustrated is a representative architecture of a suitable controller 200, depicted in FIG. 1 as the controller 106, on which operations of the subject system 100 are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. Network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and network interface subsystem 210 is suitably accomplished via a bus data transfer mechanism, such as illustrated by bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system is accomplished on a suitable document processing device that includes the controller 200 of FIG. 2 as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably via an interface local to the controller, or remotely via a remote thin or thick client.

The engine 302 is in data communication with printer function 304, facsimile function 306, and scan function 308. These devices facilitate the actual operation of printing, facsimile transmission and reception, and document scanning for use in securing document images for copying or generating electronic versions.

A job queue 312 is suitably in data communication with printer function 304, facsimile function 306, and scan function 308. It will be appreciated that various image forms, such as bit map, page description language or vector format, and the like, are suitably relayed from scan function 308 for subsequent handling via job queue 312.

The job queue 312 is also in data communication with network services 314. In a preferred embodiment, job control, status data, or electronic document data is exchanged between job queue 312 and network services 314. Thus, suitable interface is provided for network based access to the controller 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. Network services 314 also advantageously supplies data interchange with client side services 320 for communication via FTP, electronic mail, TELNET, or the like. Thus, the controller function 300 facilitates output or receipt of electronic document and user information via various network access mechanisms.

Job queue 312 is also advantageously placed in data communication with an image processor 316. Image processor 316 is suitably a raster image process, page description language interpreter or any suitable mechanism for interchange of an electronic document to a format better suited for interchange with device services such as printing 304, facsimile 306 or scanning 308.

Finally, job queue 312 is in data communication with a parser 318, which parser suitably functions to receive print job language files from an external device, such as client device services 322. Client device services 322 suitably include printing, facsimile transmission, or other suitable input of an electronic document for which handling by the controller function 300 is advantageous. Parser 318 functions to interpret a received electronic document file and relay it to a job queue 312 for handling in connection with the afore-described functionality and components.

In operation, a user obtains a coupon from a retail location, hereinafter the issuer. Prior to providing the coupon to the user, the issuer of the coupon inputs the value of the coupon and identification information associated therewith, into the server 114. The value of the coupon includes, for example and without limitation, a monetary amount, a number of copies, a number of color prints, a number of scanning operations, a number of facsimile transmissions, a document storage time limit, or the like. In accordance with the preferred embodiment the identification information includes a coupon number, or other identifying indicia to provide authentication and validation information when the coupon is used by the user. Once the value and identification information is stored on the server 114, it is incorporated into visible scanning indicia, e.g., a barcode, or other machine readable image. A coupon, including the visible scanning indicia, is then issued to the user. As will be appreciated by those skilled in the art, the coupon is capable of being provided to the user in hardcopy, i.e., paper format, or in electronic format for printing by the user prior to the use of the document processing device 102.

In the preferred embodiment, when the user desires to make use of the kiosk 108, the user logs into the document services system via the user-interface 104. Authentication and verification of the user is accomplished via any suitable means known in the art. In accordance with one embodiment of the subject application, the controller 106 associated with the document processing device 102 facilitates the authentication of the user via authentication services over the computer network 110, as will be understood by those skilled in the art. The user then inputs the coupon into the document processing device 102 via any suitable means. Preferably, the user scans the coupon using the scanning capability of the document processing device 102. Thus, the user selects a coupon payment method from the user-interface 104 and is prompted to place the coupon on the scanning portion, e.g., automatic document feeder, associated with the document processing device 102 of the kiosk 108 at which the user is physically present. The document processing device 102 then performs a scanning operation on the coupon to retrieve the visible scanning indicia. The controller 106 associated with the document processing device 102 then transmits the retrieved visible scanning indicia to the backend server 114 so as to obtain the value and identification information associated therewith.

Following receipt of the coupon value, the controller 106 associated with the document processing device 102 prompts the user to select, via the user-interface 104, the desired document processing operation. The controller 106 then determines, from the value and identification information received from the backend server 114, whether or not the requested operation is allowed. When the requested operation is not allowed under the coupon, the controller 106 associated with the document processing device 102 proceeds with alternate payment operations, as will be explained in greater detail below. When such requested operation is authorized, the controller 106 associated with the document processing device 102 calculates the costs associated with the requested document processing operations to determine whether the coupon covers the full cost, or if the cost exceeds the value associated with the coupon. When the costs exceed the value of the coupon, the user is prompted to select an alternate payment method, in addition to or in place of the value associated with the coupon. When the value of the coupon is sufficient so as to allow the performance of the requested document processing operation, the controller 106 associated with the document processing device 102 directs the device 102 to perform the requested service. The usage data generated in the performance of the requested operation is then transmitted to the backend server 114, whereupon the backend server updates the coupon value. It will be understood by those skilled in the art that when residual value remains according to the usage data, the value associated with the coupon is updated to reflect the remaining amount and is capable of being reused with respect to the updated amount. When the usage data indicates to the server 114 that no residual value remains associated with the coupon, the coupon is marked as invalid in the server 114. It will be appreciated by those skilled in the art that invalidating the coupon is capable of including physically marking the coupon using the document processing device 102.

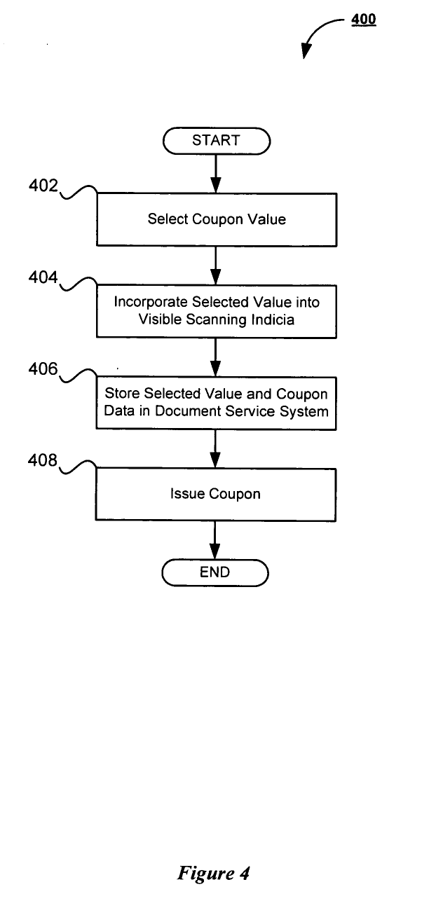

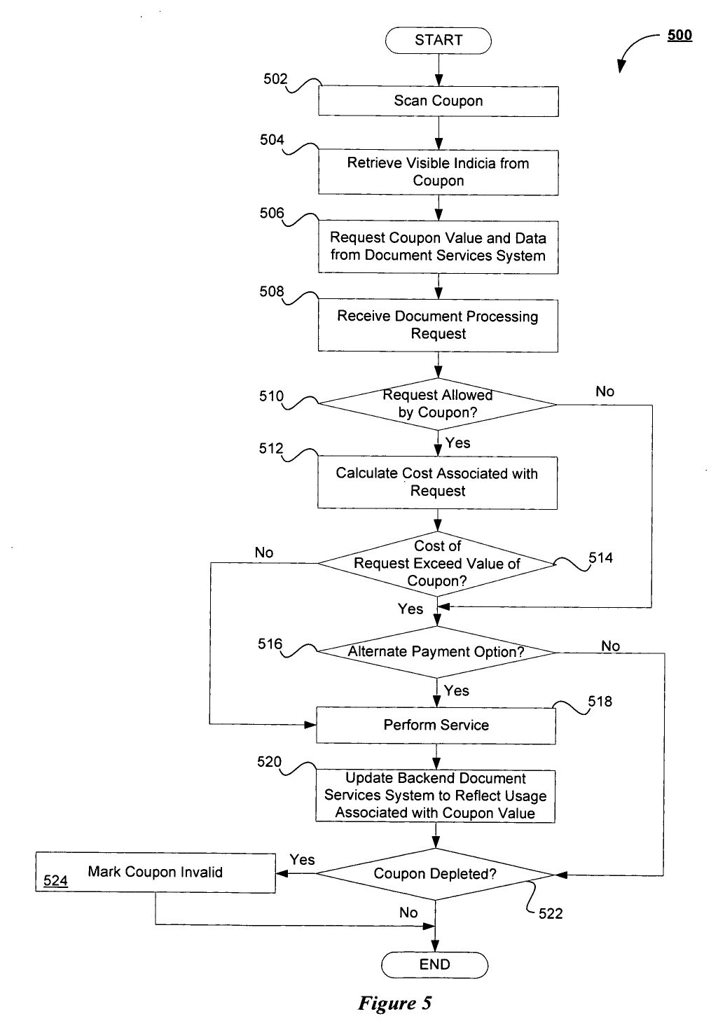

The preceding system 100 and components described above with respect to FIGS. 1, 2, and 3 will better be understood by those skilled in the art when viewed in conjunction with the flowchart 400 of FIG. 4 and the flowchart 500 of FIG. 5. Referring now to FIG. 4, there is shown a coupon generation flowchart 400 in accordance with the subject application. It will be understood by those skilled in the art that the flowchart 400 illustrates one particular embodiment of the coupon generation and issuance associated with the subject application and other embodiments are equally capable of being implemented in accordance with the subject application.

At step 402 a value is selected to be associated with a coupon for use in accordance with the subject application. The value to be associated with the coupon is capable of including, for example and without limitation, a payment amount, a number of allowed copies, a number of allowed print jobs, a number of allowed facsimile transmissions, a number of electronic mail messages, or the like. The skilled artisan will appreciate that other factors, such as group discounts, bulk discounts, and the like, are capable of being employed during the calculation of the value of the coupon. Preferably, the user transfers a monetary amount to a retail location, automated coupon issue machine, or the like. At step 404, the selected value is incorporated into visible scanning indicia, such as, for example and without limitation, a two-dimensional barcode, or other machine readable image. The retail location, or issuer of the coupon, then submits the value and any associated identification information to the backend server 114 for storage at step 406. The coupon is then issued to the user at step 408. As previously mentioned, suitably issuance includes, for example and without limitation, providing the user with a paper coupon, an electronic mail message for hardcopy output, or the like.

In accordance with one aspect of the subject application, a user is able to access, via a suitable web portal, a coupon procurement website, whereupon the user selects a value to be added to a coupon. Preferably, such access is accomplished from a user device connected to the document services system via the Internet. The user makes payment in the form of a transfer of funds from a checking, savings, or group account, or a credit or debit card payment. This payment then corresponds to the value amount to be added to the coupon. The user is then presented, at his user device, with a printable version of the coupon. Upon output of the coupon via an attached output device, the user is able to travel to a kiosk 108 location, and thereafter use the coupon to request document processing operations from the associated document processing device 102.

FIG. 5 advantageously displays a flowchart 500 illustrating the method for implementing scanable coupons in accordance with the subject application. It will be appreciated by those skilled in the art that FIG. 5 illustrates the method whereupon the user, having a hardcopy of a coupon associated the document services system, is able to request document processing operations from one of the document processing devices associated with the system. When the user desires to make use of the document processing services provided by the kiosk 108, the user approaches the document processing device 102, and scans the coupon at step 502. It will be understood by those skilled in the art that the user initiates the scanning via the user-interface 104 associated with the document processing device 102. The controller 106 associated with the document processing device 102 then retrieves, at step 504, the visible scanning indicia from the coupon. That is, the document processing device 102 scans the coupon and controller 106 associated with the device 102 retrieves the information stored in the barcode printed on the coupon. Using the visible scanning indicia, the controller 106 requests the value and other identification information associated with the scanned coupon from the backend server 114 at step 506.

The value and information associated with the coupon is then received from the backend server 114 and the user inputs a document processing request at step 508. A determination is then made by the controller 106 at step 510 whether the document processing request is allowed by the coupon. For example, the coupon is capable of only authorizing copies and not facsimile transmissions, or print jobs, but not scanning to storage jobs. When the requested operation is not authorized by the coupon, flow proceeds to step 516, whereupon the user is prompted to select an alternate payment option. In accordance with one aspect of the subject application, alternate payment options include, for example and without limitation, credit card payment, cash, group account, or the like. Preferably, such alternate payment is capable of being received at the kiosk 108, via suitable currency receptacle, magnetic card reader, and the like. It will be appreciated by those skilled in the art, the alternate payment method is first verified by the backend server 114 prior to enabling performance of the requested service. When no alternate payment is selected at step 516, flow proceeds to step 522, whereupon a determination is made by the controller 106 whether the coupon has been depleted, i.e., whether no value remains associated with the coupon. When no value remains, flow proceeds to step 524, whereupon the coupon is marked as invalid and operations terminate.

When the user has selected and provided an alternate payment option at step 516, flow proceeds to step 518, whereupon the requested service is performed by the document processing device 102. At step 520, the backend server 114 updates the value of the coupon to reflect the performance of the requested operation. It will be understood by those skilled in the art that when the coupon did not authorize the requested document processing operation, i.e., only alternate payment was accepted, no modifications to the value associated with the scanned coupon are made by the server 114 at step 520.

Returning to step 510, when the controller 106 associated with the document processing device 102 determines that the requested operation is allowed under the terms of the issued coupon, flow progresses to step 512, whereupon the cost associated with the requested operation is calculated. In accordance with the subject application, the cost is capable of being determined using, for example and without limitation, the length of time of the document storage, the number of copies, the size of the file being transmitted, the number of pages in a facsimile transmission, the color content of a print job, or the like. A determination is then made by the controller 106 at step 514 whether the costs of the selected operation exceeds the value of the coupon. When the costs do exceed the values, flow proceeds to step 516 for user selection of an alternate payment method and operation of the method continues as set forth above.

When the cost associated with the requested document processing operation does not exceed the value of the coupon, flow proceeds to step 518, whereupon the requested operation is performed by the document processing device 102. Flow then proceeds to step 520, whereupon usage data is transmitted to the backend server 114 so as to reflect the value of the services provided. A determination is then made by the controller 106 associated with the document processing device 102 at step 522 whether the performance of the selected services has depleted the value associated with the coupon. When all value associated with the coupon has been used, i.e., the coupon is depleted, flow proceeds to step 524, whereupon the coupon is marked as invalid, thereby preventing its use by the user for subsequent operations. It will be appreciated by those skilled in the art that such marking is capable of including, for example and without limitation, confiscation of the coupon by the document processing device 102, reprinting the coupon such that the barcode indicates its depleted state, printing over the coupon to render the barcode illegible, or any suitable combination thereof. It will be understood by those skilled in the art that when residual value remains according to the usage data, the value associated with the coupon is updated to reflect the remaining amount and is capable of being reused with respect to the updated amount.

The subject application extends to computer programs in the form of source code, object code, code intermediate sources and object code (such as in a partially compiled form), or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A scanable coupon system for document processing devices comprising:
scanning means adapted for scanning a visible indicia on an associated tangible document, which visible indicia includes encoded data representative of a preselected value associated with use of a document processing device;
means adapted for generating coupon data in accordance with a scan of visible indicia of a tangible document completed by the scanning means;
means adapted for receiving a document processing request for the document processing device;
means adapted for calculating a charge value associated with a received document processing request; and
enabling means adapted for selectively enabling operation of the document processing device in accordance with a calculated charge value and generated coupon data.

2. The scanable coupon system for document processing devices of claim 1 further comprising:
means adapted for communicating coupon data via a network to an associated server;
means adapted for generating, at the associated server, credit data corresponding to the coupon data; and
means adapted for communicating credit data from the associated server to the document processing device wherein the enabling means includes means adapted for enabling operation of the document processing device in accordance with the credit data.

3. The scanable coupon system for document processing devices of claim 1 further comprising:
comparison means adapted for calculating relative values of the credit data and the charge value;
means adapted for prompting a user for payment data upon a determination by the comparison means that the charge value exceeds the credit data;
means adapted for receiving payment data corresponding to a difference between the charge value and the credit data; and
wherein the enabling means includes means adapted for selectively enabling operation of the document processing device upon receipt of payment data.

4. The scanable coupon system for document processing devices of claim 1 wherein the visible indicia further includes unique identification data corresponding thereto; and further comprising means adapted for generating data representative of at least one of invalidation or value limitation corresponding to the unique identification data upon enabling operation of the document processing device.

5. The scanable coupon system for document processing devices of claim 1 wherein the enabling means enables operation of the document processing device to perform a document processing operation specified by the coupon data.

6. The scanable coupon system for document processing devices of claim 1 wherein the scanning means includes means for commencing a scanning of the visible indicia upon receipt of a coupon input signal from an associated user.

7. A method for scanning coupons for document processing devices comprising the steps of:
scanning a visible indicia on an associated tangible document, which visible indicia includes encoded data representative of a pre-selected value associated with use of a document processing device;
generating coupon data in accordance with a scan of visible indicia of a tangible document completed by the scanning means;
receiving a document processing request for the document processing device;
calculating a charge value associated with a received document processing request; and
selectively enabling operation of the document processing device in accordance with a calculated charge value and generated coupon data.

8. The method for scanning coupons for document processing devices of claim 7 further comprising the steps of:
communicating coupon data via a network to an associated server;
generating, at the associated server, credit data corresponding to the coupon data; and
communicating credit data from the associated server to the document processing device wherein the enabling means includes means adapted for enabling operation of the document processing device in accordance with the credit data.

9. The method for scanning coupons for document processing devices of claim 7 further comprising the steps:
calculating relative values of the credit data and the charge value;
prompting a user for payment data upon a determination by the comparison means that the charge value exceeds the credit data;
receiving payment data corresponding to a difference between the charge value and the credit data; and
selectively enabling operation of the document processing device upon receipt of payment data.

10. The method for scanning coupons for document processing devices of claim 7 wherein the visible indicia further includes unique identification data corresponding thereto; and further comprising the step of generating data representative of at least one of invalidation or value limitation corresponding to the unique identification data upon enabling operation of the document processing device.

11. The method for scanning coupons for document processing devices of claim 7 wherein the step of selectively enabling operation enables operation of the document processing device to perform a document processing operation specified by the coupon data.

12. The method for scanning coupons for document processing devices of claim 7 wherein the step of scanning includes commencing a scanning of the visible indicia upon receipt of a coupon input signal from an associated user.

13. A computer-implemented method for scanning coupons for document processing devices comprising the steps of:
scanning a visible indicia on an associated tangible document, which visible indicia includes encoded data representative of a pre-selected value associated with use of a document processing device;
generating coupon data in accordance with a scan of visible indicia of a tangible document completed by the scanning means;
receiving a document processing request for the document processing device;
calculating a charge value associated with a received document processing request; and
selectively enabling operation of the document processing device in accordance with a calculated charge value and generated coupon data.

14. The computer-implemented method for scanning coupons for document processing devices of claim 13 further comprising the steps of:
communicating coupon data via a network to an associated server;
generating, at the associated server, credit data corresponding to the coupon data; and
communicating credit data from the associated server to the document processing device wherein the enabling means includes means adapted for enabling operation of the document processing device in accordance with the credit data.

15. The computer-implemented method for scanning coupons for document processing devices of claim 13 further comprising the steps:
calculating relative values of the credit data and the charge value;
prompting a user for payment data upon a determination by the comparison means that the charge value exceeds the credit data;
receiving payment data corresponding to a difference between the charge value and the credit data; and
selectively enabling operation of the document processing device upon receipt of payment data.

16. The computer-implemented method for scanning coupons for document processing devices of claim 13 wherein the visible indicia further includes unique identification data corresponding thereto; and further comprising the step of generating data representative of at least one of invalidation or value limitation corresponding to the unique identification data upon enabling operation of the document processing device.

17. The computer-implemented method for scanning coupons for document processing devices of claim 13 wherein the step of selectively enabling operation enables operation of the document processing device to perform a document processing operation specified by the coupon data.

18. The computer-implemented method for scanning coupons for document processing devices of claim 13 wherein the step of scanning includes commencing a scanning of the visible indicia upon receipt of a coupon input signal from an associated user.
